(19) United States
(12) Patent Application Publication
(10) Pub. No.: US 2014/0048676 A9
(43) Pub. Date: Feb. 20, 2014

(54) Universal Object Retention System With Tactile Feature

(71) Applicant: ORANGE22 DESIGN LAB, LLC, Playa Vista, CA (US)

(72) Inventor: Dario Cesar Antonioni, Playa Vista, CA (US)

(73) Assignee: ORANGE22 DESIGN LAB, LLC, Playa Vista, CA (US)

(21) Appl. No.: 13/761,822

(22) Filed: Feb. 7, 2013

Related U.S. Application Data
(63) Continuation-in-part of application No. 11/891,508, filed on Aug. 10, 2007.

(51) Int. Cl. F16M 11/04

(52) U.S. Cl. CPC F16M 11/04
USPC 248/614; 248/560

(57) ABSTRACT

Various embodiments may be generally directed to a universal object retention system that may be configured with at least a support substrate and a plurality of ductile members extending across predetermined portions of the support substrate. At least one ductile member may be configured with a tactile feature that increases friction between the support substrate and the ductile feature.

### RELATED APPLICATION

This application is a continuation-in-part of copending U.S. patent application Ser. No. 13/385,596 filed on Sep. 6, 2011 entitled, “Universal Object Retention System and Method Thereof”

### SUMMARY

Various embodiments of the present disclosure are generally directed to a system for retaining a variety of different objects.

In accordance with some embodiments, a universal object retention system that may be configured with at least a support substrate and a plurality of ductile members extending across predetermined portions of the support substrate. At least one ductile member may be configured with a tactile feature that increases friction between the support substrate and the ductile feature.

These and other features and advantages which characterize the various embodiments of the present invention can be understood in view of the following detailed discussion and the accompanying drawings.

### BRIEF DESCRIPTION OF THE DRAWINGS

FIG. 1 is a perspective view of a portion of an example universal object retention system constructed and operated in accordance with various embodiments.

FIG. 2 shows a top view of an example universal object retention system in accordance with some embodiments.

FIG. 3 generally illustrates a top view of an example universal object retention system in accordance with various embodiments.

FIG. 4 respectively provides a top view of an example universal object retention system in accordance with some embodiments.

FIG. 5 respectively provides a top view of an example universal object retention system in accordance with some embodiments.

FIG. 6 respectively provides a top view of an example universal object retention system in accordance with some embodiments.

FIG. 7 displays perspective views of an example universal object retention system operated in accordance with various embodiments, with

FIG. 8 is a perspective view of an example universal object retention system operated in accordance with some embodiments.

FIG. 9 illustrates a perspective view of an example universal object retention system operated in accordance with various embodiments.

FIG. 10 provides a front view of an example universal object retention system constructed in accordance with various embodiments.

FIG. 11 shows a perspective view of an example universal object retention system operated in accordance with some embodiments.

FIG. 12 is a perspective view of an example universal object retention system operated in accordance with various embodiments.

FIG. 13 generally illustrates a perspective view of an example universal object retention system operated in accordance with some embodiments.

FIG. 14 displays a perspective view of an example universal object retention system operated in accordance with various embodiments.

FIG. 15 provides a top view of an example universal object retention system constructed in accordance with various embodiments.

FIG. 16 respectively illustrates a perspective view of an example universal object retention system constructed and operated in accordance with some embodiments.

FIG. 16A respectively illustrates a view of an example universal object retention system constructed and operated in accordance with some embodiments.

FIG. 16B respectively illustrates a view of an example universal object retention system constructed and operated in accordance with some embodiments.

FIG. 16C respectively illustrates a view of an example universal object retention system constructed and operated in accordance with some embodiments.

FIG. 16D respectively illustrates a view of an example universal object retention system constructed and operated in accordance with some embodiments.

FIG. 17 is a top view of an example universal object retention system constructed in accordance with various embodiments.

FIG. 18 displays a side view of a portion of an example universal object retention system constructed in accordance with some embodiments.

FIG. 19 shows a front view of a portion of an example universal object retention system constructed in accordance with various embodiments.

FIG. 20 provides a front view of a portion of an example universal object retention system constructed in accordance with some embodiments.

FIG. 21 illustrates a front view of a portion of an example universal object retention system constructed in accordance with various embodiments.

FIG. 22 is a top view of an example universal object retention system constructed in accordance with some embodiments.

FIG. 22A respectively displays a perspective view of an example universal object retention system in various example environments.

FIG. 22B respectively displays a perspective view of an example universal object retention system in various example environments.

FIG. 22C respectively displays a perspective view of an example universal object retention system in various example environments.

FIG. 22D respectively displays a perspective view of an example universal object retention system in various example environments.

FIG. 23 provides a perspective view of an example universal object retention system constructed in accordance with some embodiments.

FIG. 24 shows a front view of a portion of an example universal object retention system constructed and operated in accordance with various embodiments.

FIG. 25 respectively provides a front view of an example universal object retention system constructed in accordance with some embodiments.

FIG. 25A respectively provides a front view of an example universal object retention system constructed in accordance with some embodiments.

FIG. 26 respectively illustrates a perspective view of an example universal object retention system constructed in accordance with various embodiments.

FIG. 26A respectively illustrates a perspective view of an example universal object retention system constructed in accordance with various embodiments.

FIG. 27 respectively shows a perspective view of an example universal object retention system constructed in accordance with some embodiments.

FIG. 27A respectively shows a perspective view of an example universal object retention system constructed in accordance with some embodiments.

FIG. 28 is a perspective view of an example universal object retention system constructed in accordance with various embodiments.

FIG. 29 is a perspective view of an example universal object retention system operated in accordance with some embodiments.

### DETAILED DESCRIPTION

The object retention system disclosed herein generally relates to a device for storing a one or more objects with a wide variety of shapes, sizes, and weights such as personal articles, digital gear, electronic gadgets, and cosmetics. With the increased mobility and reduction in size of many personal accessories, like cellular phones, media players, and car keys, simple pockets and sleeves are often not properly proportioned to securely engage such personal accessories. Hence, there is a continued industry demand for efficient means of securing a number of accessories of varying size and weight.

Accordingly, a universal object retention system can be configured with a plurality of ductile members extending across predetermined portions of a support substrate with at least one ductile member having a tactile feature configured to increase friction between the ductile member and the support substrate. The inclusion of a tactile feature on at least one ductile member can increase the ability to secure items between the ductile member and the support substrate. Moreover, the addition of the tactile feature can provide enough friction to secure larger, heavier items than may be secured by ductile members without a tactile feature.

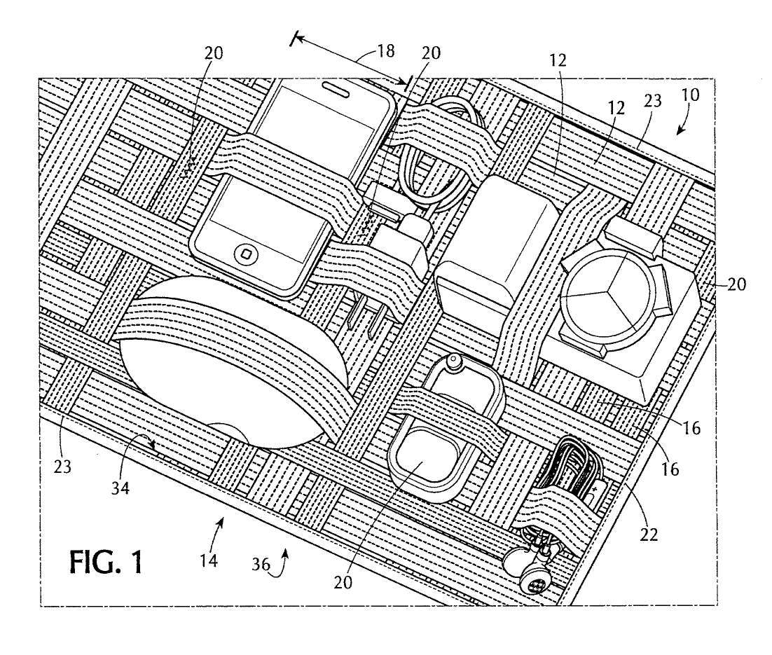

While not limited to a particular material, environment, and size, various embodiments can be practiced in a manner depicted by the example object retention system 10 shown in FIG. 1. The object retention system 10 is shown with a plurality of ductile members 12 that extend across predetermined portions of a support substrate 14. The ductile members 12 can be constructed of similar or dissimilar materials, such as elastic, polymers, and plastic, with similar or dissimilar widths and lengths that are partially stretched in predetermined orientation with respect to the support substrate 14. That is, a first ductile member can be constructed of a first material, such as elastic, with a first width, such as one inch, that extends along a first direction with respect to the support substrate 14 while a second ductile member is configured with a different second material, such as plastic, and with a different second width, such as one-half an inch, extending along a different second direction over the support substrate 14.

More than one ductile member 12 can be grouped into a plurality of members that are similarly configured to be parallel, orthogonal, and angled with respect to the support substrate 14. In other words, a number of ductile members 12 can each be constructed to extend across the support substrate in a similar manner, such as vertically along a transverse axis or horizontally along a longitudinal axis of the support substrate 14. The ability to tune the size, material, and orientation on the support substrate 14 allows for the retention of objects with wide varieties of sizes and weights.

As shown in FIG. 1, various embodiments configure a first plurality of ductile members 12 to contact a first pair of opposite sides of a substantially rectangular support substrate while a second plurality of ductile members 12 contact a different second pair of opposite sides of the support substrate 14. The different orientations of the first 12 and second pluralities 16 of ductile members 12 can provide options for engaging an object; such as contacting an object with multiple members 12 from the first plurality and multiple members 12 from both the first and second pluralities. The retention of an object may be enhanced with the weaving of the ductile members 12, as displayed, so that a particular ductile member 12 is both contacting the support substrate 14 and separated from the substrate 14 by a different ductile member 12 along the length of the support substrate 14.

The interweaving of ductile members 12 can provide additional tuning options for the object retention system 10 as various widths and materials of the ductile members 12 can be interwoven in a random or patterned configuration. As such, retention regions can be created in a variety of differently sized retention regions 18 by selectively stretching of one or more ductile members 12 between other interwoven ductile members 12.

While not limited to a particular material, some embodiments configure the support substrate 14 as a rigid material, such as ABS plastic, sufficient to retain a predetermined shape, such as fiat, convex, and concave, despite tension in the ductile members 12. By way of example and not limitation, the support substrate may be formed of a medium density fiberboard, corkboard, or dry erase board that can be utilized as a support for various external accessories, like thumbtacks, markers, and screws. Regardless of the construction of the support substrate 14, the various pluralities of ductile features 12 and 16 may be interwoven together to provide retention regions 18 sized hold specific or generally sized objects (e.a., electronic components, phone, pencil, etc.). For example, the ductile members 12 can be attached to the support substrate 14 at intermediate positions 20 within its perimeter to increase the holding force of a retention region 18.

FIG. 3 illustrates a top view of an example universal retention system configured with a random interweaving of first and second ductile member 12 pluralities. As displayed by the various segmented tines, the support substrate 14 cart be shaped in a variety of non-limiting sizes and shapes to which the first plurality of ductile members 12 extend along a first horizontal direction across the support substrate 14 while the second plurality of ductile members 12 extend vertically across the support substrate 14, orthogonal to the first plurality of ductile members 12.

The random interweaving of the pluralities of ductile members 12 are complemented by at least one anchor feature 20 where ductile members 12 are affixed to the support substrate 14 via a fastener, such as a such, staple, and glue. Various embodiments configure the fasteners in predetermined patterns, like one anchor feature 20 per inch, row, and section defined by the pluralities of ductile members 12.

FIG. 4 provides an example universal object retention system with anchor features 20 configured in predetermined patterns on a single layer of ductile members 12 oriented in a uniform direction across the underlying support substrate 14. Continuous stitching or a number of separate stitches can be used to form isolated or overlapping geometric shapes, such as a hexagon 42, star 44, and circle 46.

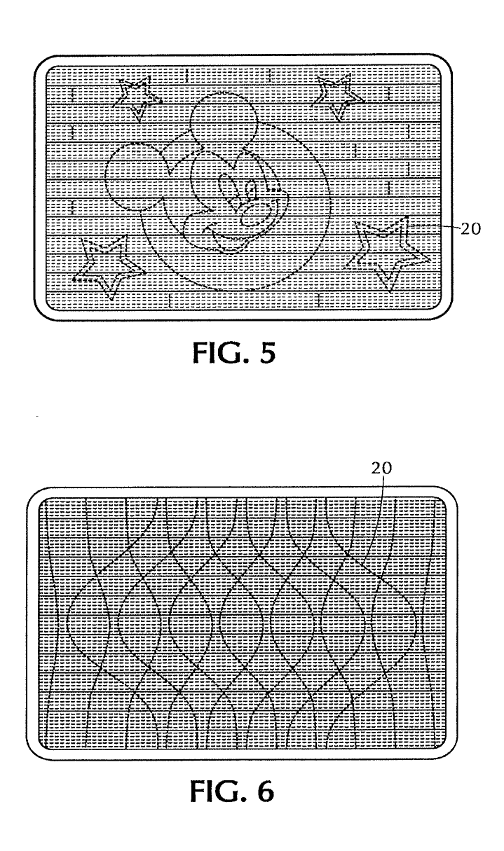

The position and length of the various anchor features 20 are not the only manner of tuning the affixing of the ductile members 12 to the support substrate 14 as the anchor features 20 may be perpendicular, skewed or aligned in relation to the direction of extension of the ductile members 12 across the support substrate 14. Such anchor feature 20 tuning capabilities may be used to create pockets 48 or create retention regions 18 for holding the objects. In some embodiments, the anchor features 20 may individually or collectively form copyrightable material, as shown in FIG. 5, or a type of artwork, as displayed in FIG. 6.

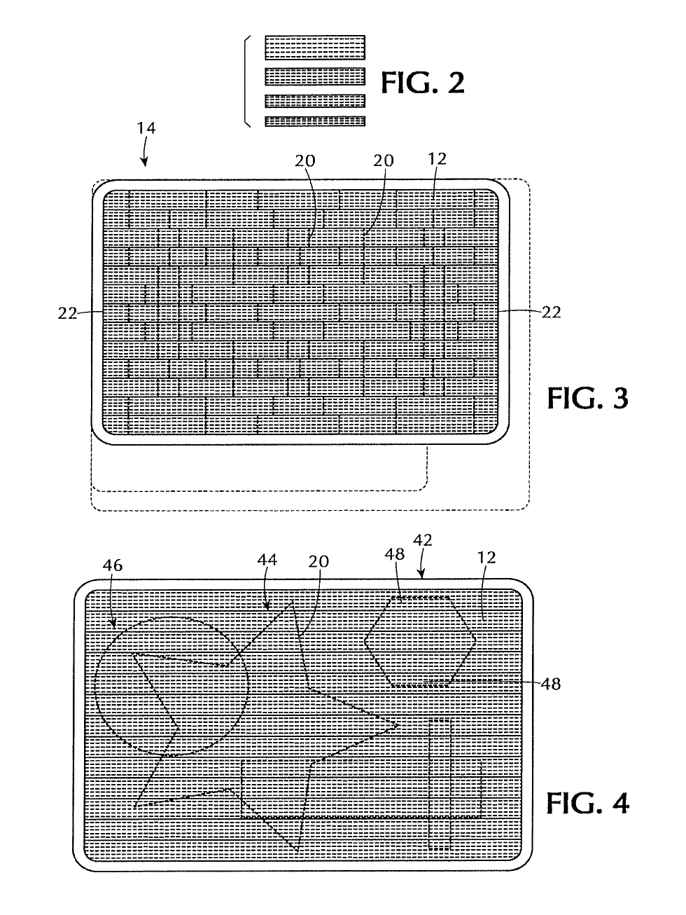

It should be noted that the object retention system 10 may include only the first set of elastic bands 12 as shown in FIGS. 3-6. Although the first set of horizontal ductile member 12 is shown in FIGS. 3-6, some embodiments include only the second set of vertical ductile members 16. Moreover, the ductile member of the first and/or second pluralities of ductile members 12 and 16 may have varying widths as shown in FIG. 2. The first and second pluralities of ductile members may be secured to a first and/or second side of the support substrate 14. Moreover, the anchor features 20 can secure intermediate positions or portions of the ductile members 12 to form retention regions 18 while defining a predetermined pattern.

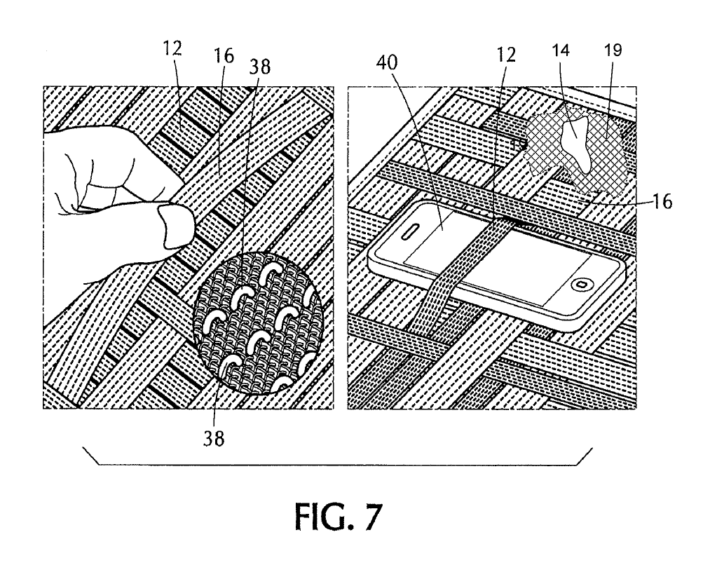

The tuned configuration of interwoven first and second pluralities of ductile members 12 may add strength to predetermined retention regions 18 to allow for secure engagement of objects with higher weights, like mobile electronic phones, computers, and other devices. However, the glossy texture and lack of attachment options in electronic devices can be difficult to secure even if a retention region is precisely sized. Thus, a tactile feature 38 can be positioned in ductile members 12 to increase friction between the ductile members 12 and the support substrate 14. FIG. 7 generally illustrates how a tactile feature 38 can be implemented into a ductile member 12 as one or more strands of polymer, such as rubber, that are affixed, interwoven, and connected to predetermined portions of the ductile member 12.

The addition of tactile feature 38 to one or more ductile members 12 can provide a non-slip material that contacts an attached object 40 with islands of polymer material that increase the coefficient of friction between the ductile member 20 and the support substrate 14, as opposed to a continuous surface supplied by the ductile members 12 without the addition of the tactile feature 38. Some embodiments uses a single polymer string, such as a string sold under the trademark GOODY STAYPUT as manufactured and sold by NEWELL CO, interwoven along the entire length of the ductile member 20. The use of numerous strands of polymer material either uniformly or non-uniformly spaced across a single ductile member 20 can form a tactile feature 38 that can be configured to extend a distance less than the length of the support substrate 14.

As a non-limiting example, less than all of the first plurality of ductile members 12 have evenly spaced strands of non-slip material forming tactile features 38 that extend for intermittent portions of the support substrate 14 white the second plurality of ductile members have non-evenly spaced strands of non-slip material extending continuously along the length of the ductile members 12. The use of at least one tactile feature 38 can be complemented by the position of a friction feature between the support substrate 14 and the ductile members 12. The friction feature can be configured in an unlimited variety of materials and shapes that promote friction, but in some embodiments the friction feature is constructed as a continuous sheet of a non-slip material that has varying thicknesses, which can promote the retention of objects. It can be appreciated that by tuning the material and position of the tactile features 38 and friction feature, the ability to secure Objects 40 can be optimized.

FIG. 7 further shows non-slip member 19, also referred to herein as slip resistant member 19, disposed between the support substrate 14 and the ductile members 12. Preferably, the slip resistant member is formed from a compressible polymer, which displays a coefficient of friction sufficient to mitigate inadvertent movement of an object confined under at least one of the plurality of ductile members, and on top of the slip-resistant member 19.

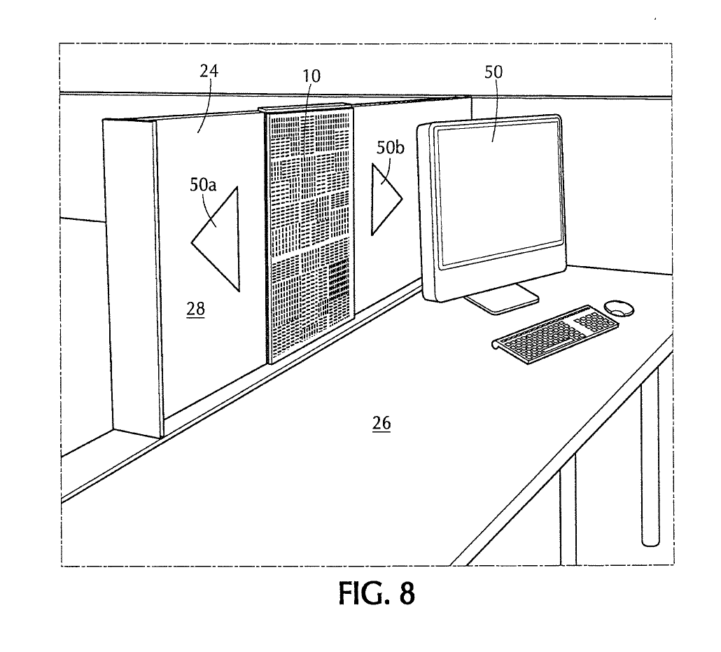

Turning to FIG. 8, an example object retention system 10 is shown being incorporated into apiece of furniture. As shown, the object retention system 10 is incorporated into a panel or office divider 24, however, the object retention system 10 may be temporarily secured to the panel 24 so that the object retention system 10 can be traversed (or slid) left or right 50a, b. The object retention system 10, in some embodiments, is configured to hook onto the panel 24 to facilitate the sliding movement and temporary engagement of the system 10 to a predetermined section of the panel 24.

The panel 24 may be a dry erase board 28 or a pitiable surface. By moving the object retention system 10, various portions of the dry erase board 28 can be revealed. A user can mount objects 40 to the object retention system 10 to clear clutter from the table top 26. The Objects 40 can be slid behind the monitor 50 when not in use and slid in the direction of 50a when access to the objects 40 is required. In this manner, the user has access to the dry erase board 28 as well as the object retention system 10 as desired and needed. The object retention system 10 may be slidable left or right 50a and 50b with respect to the panel 24 through any non-limiting mechanism, such as tongue and groove, ball bearings, and rollers.

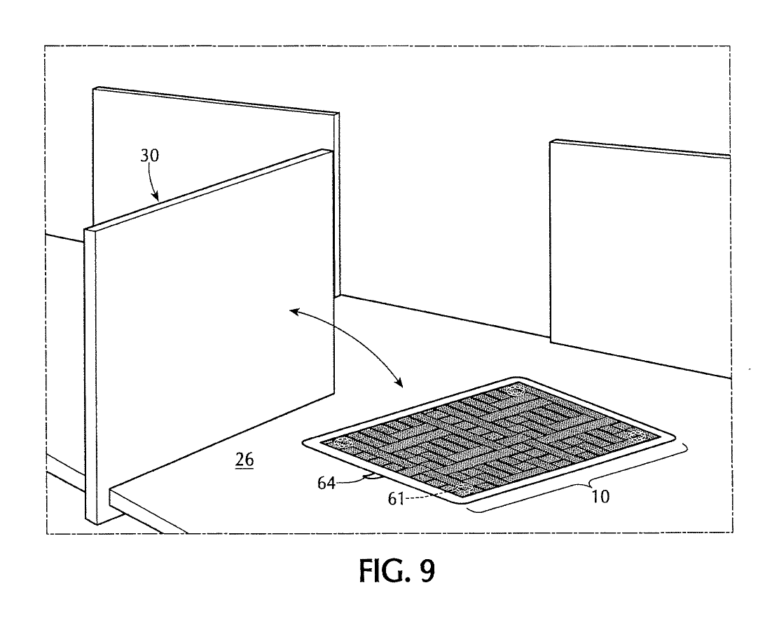

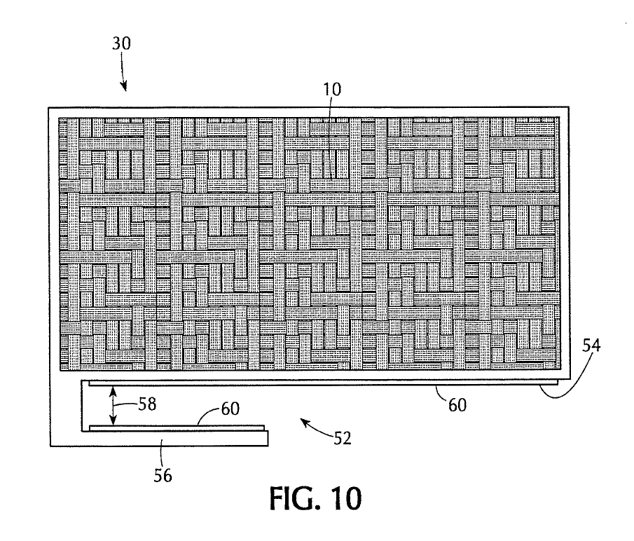

Connection to furniture can also be facilitated with various other, non-limiting means. FIGS. 9 and 10 respectively illustrate an example object retention system 10 that may be incorporated into an adjustable divider 30 that can be placed at any position on the table top 26. The adjustable divider 30 may be utilized to separate coworkers in a bullpen office environment. The divider 30 may have a c-shaped channel 52. The bottom edge 54 and a horizontal bar 56 may define a gap 58 that is sized and configured to snuggly receive a thickness of the table top 26, as shown in FIG. 9. Magnets 60 attached to the bottom edge 54 and the horizontal bar 56 may secure the object retention system 10 to the magnetizable table top 26.

Additionally, non-slip linings may line the bottom edge 54 and the horizontal bar 56 to prevent slippage or movement of the divider 30 after engagement to the table top 26. The object retention system 10 may be co-extensive with the sides of the divider 30 as shown in FIG. 10. The object retention system 10 may be removable from the divider 30 to reveal an underlying dry erase board 28, chalkboard and pin up board without limitation. Various embodiments mount the object retention system 10 to the divider 30 with the use of a plurality of magnets 61. By way of example and not limitation, magnets 60 may be secured to the underside or second side 36 of the support substrate 14. The magnet 60 may be attracted to the divider 30 which may be fabricated from or embedded with material to which the magnet 60 is attracted to (e.g., iron, etc.).

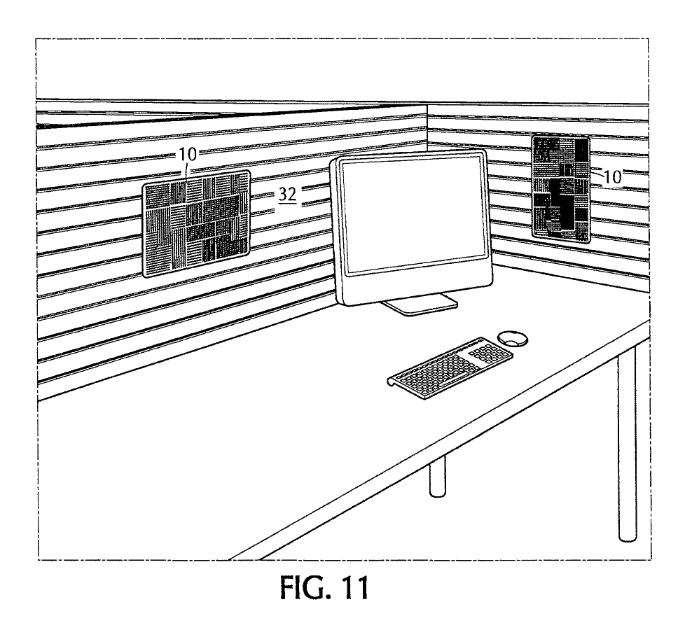

In FIG. 11, a universal object retention system 10 is displayed in accordance with some embodiments that mounts the system 10 to a slat wall panel 32. The backside or second side 36 of the object retention system 10 may have hooks that are removably attachable to the grooves formed in the slat wall panel 32. With such hook and groove engagement, the object retention system 10 can be mounted at any location on the slat wall panel 32 to customize the work space of a user. The object retention system 10 may be attached to the slat wall panel 32 in landscape or portrait orientation, which allows for diverse use of the object retention system. Such diverse use may aid with organization and management of numerous small objects, such as pens, pencils, markers, reading glasses, cell phones, erasers, and stapler removers, which are typically stored in a drawer or other storage bin when not in use.

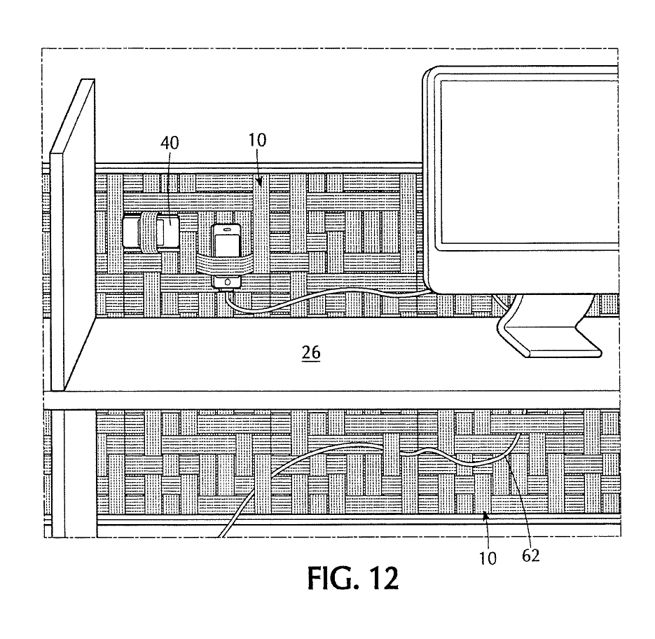

While the object retention system 10 can be constructed on a portable support substrate 14, such configuration is not required as a stationary support substrate may be employed, as desired. FIG. 12 generally illustrates a perspective view of such an example object retention system 10 implemented as a permanent part of furniture. Pluralities of ductile members 12 and 16 may be attached to a panel or wall in any variety of interwoven, anchored, and shaped configurations. The configuration of the ductile members can allow cables to be routed under one or more of the ductile members 12 and 16 to manage and organize the cables. Additionally, objects 40 may also be secured to the various ductile members of the object retention system 10. Various embodiments may further dispose ductile members under the table top 26 to route cables 62 between various points without clutter.

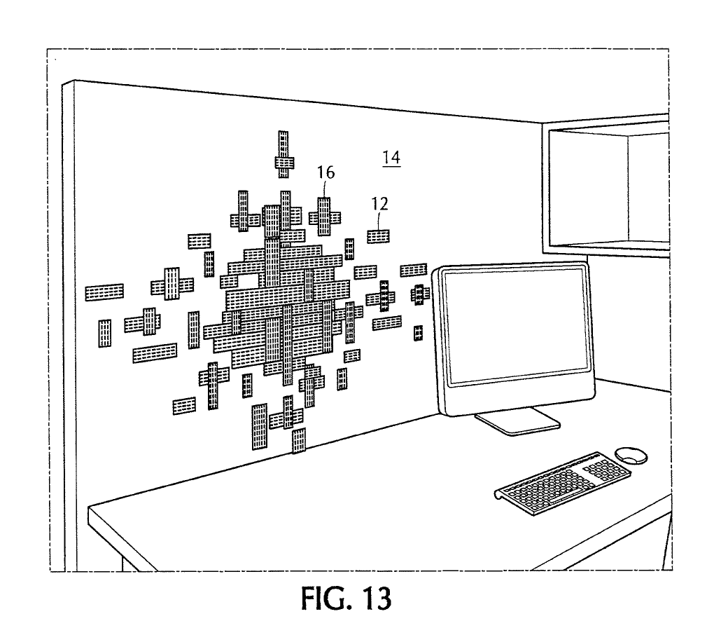

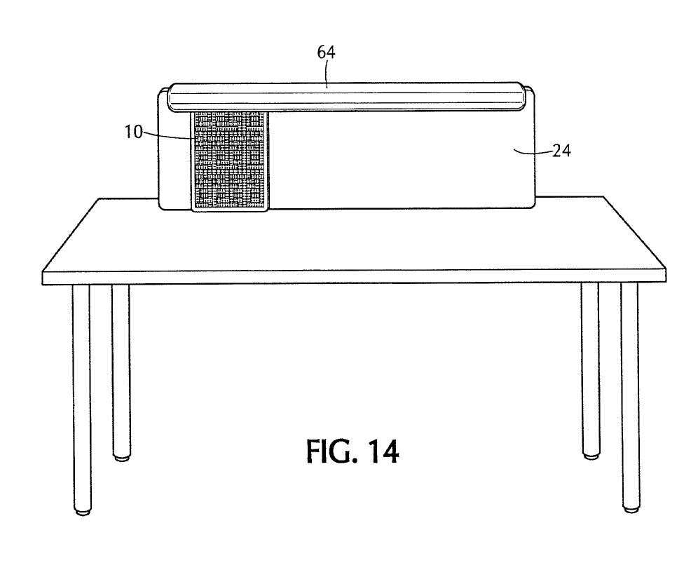

FIG. 13 displays an example object retention system 10 integrated into a furniture panel by being woven and affixed to the panel 14 so that collectively, the ductile members 12 and 16 form an aesthetically pleasing pattern that extends to less than the entirety of the underlying panel 14. The various ductile members 12 and 16 may be integrated into the panel 14 by being configured to extend underneath and over a fabric watt coverings or wallpaper.

FIG. 14 shows another example use of an example object retention system 20 as being removably attachable to the panel 24 by way of a clip 64. Such a clipped attachment between the object retention system 10 and the panel 24 may allow for diverse orientation of the various ductile members without having to affix the system 10 to the panel 24.

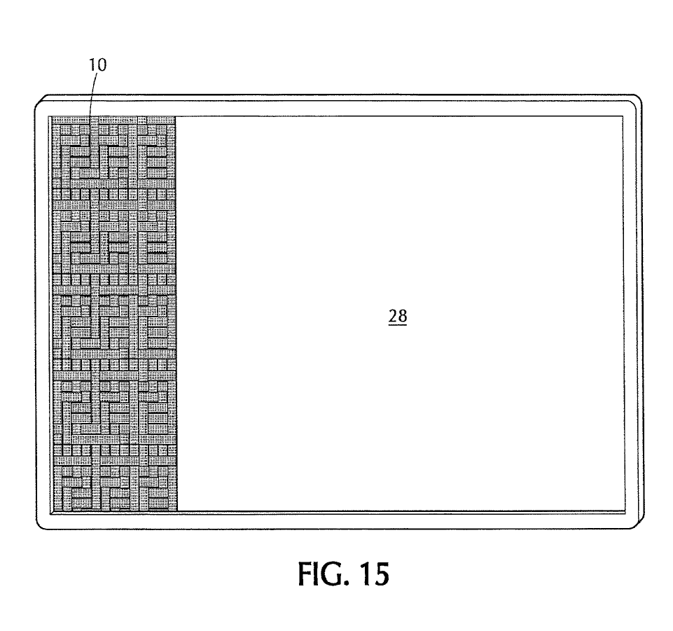

Turning to FIG. 15, an example object retention system 10 is shown as configured to comprise both a plurality of interwoven ductile members and a utility region. While the utility region is not limited to a particular construction, corkboard, dry erase board, and chalkboard may be permanently or slidingly engaged to cover some or all of the ductile members. With a sliding configuration, the object retention system 10 may be used to hold the dry erase pens, which can correspond to tuned material, width, and inclusion of tactile features in some or all of the ductile members. Some embodiments further configure the object retention system 10 with a loop or hook for engaging the object retention system 10 with a panel.

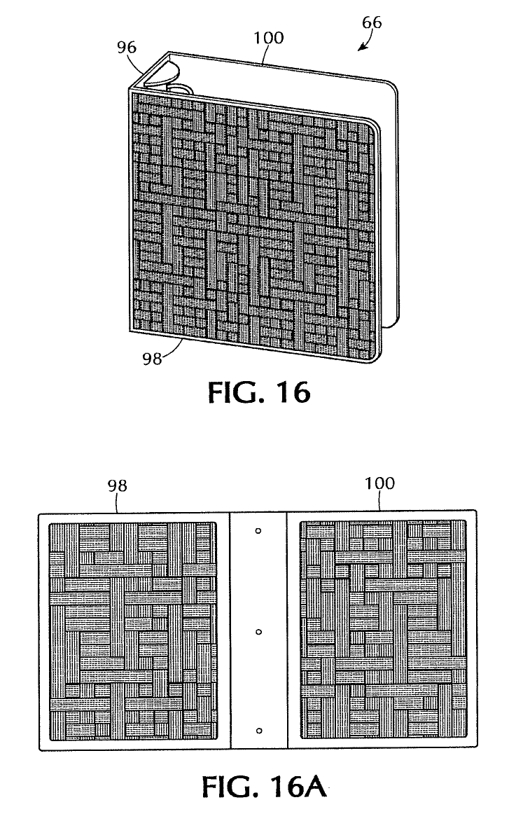

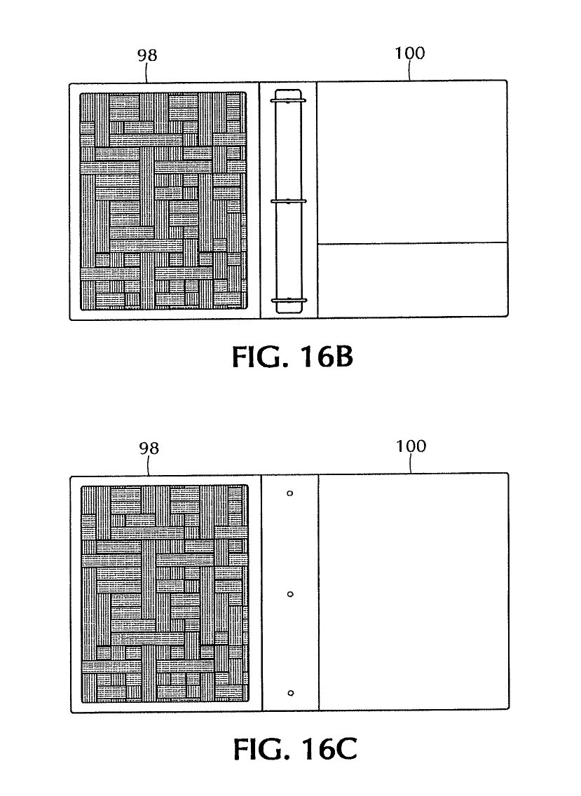

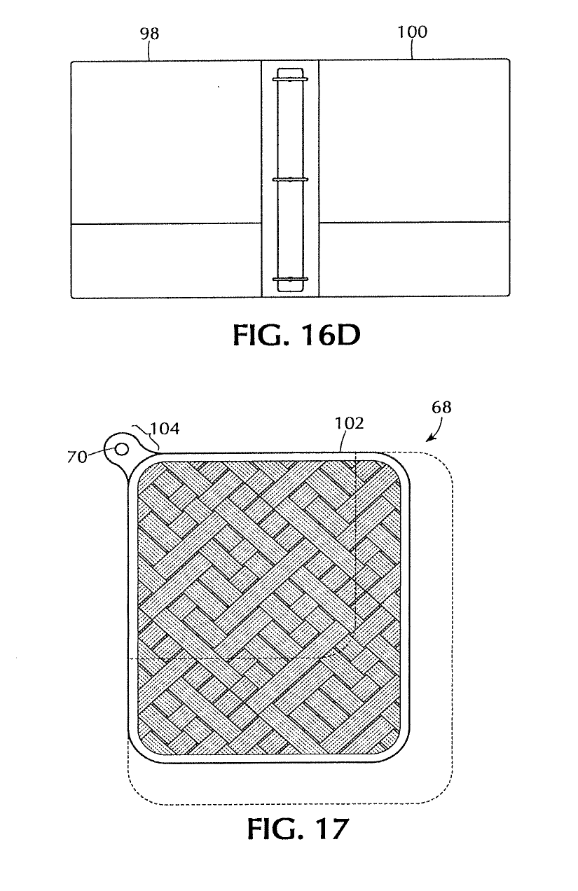

An example object retention system 10 that is integrated into a binder 66 is displayed in FIGS. 16-16D. While a binder 66 is shown, the implementation of ductile members to one or more sides of a folder, tablet, and clipboard are not excluded. The binder 66 may be a 3-ring binder or other type of binder, such as a 2-ring binder, that have pocket portfolios, report covers, and sleeves. The binder 66 has a spine 96, front cover 98 and aback cover 100 that can individually or collectively be connected to one or more ductile members that have a tactile feature. The object retention system 10 may be incorporated into either one of the exterior surfaces of the front and back covers 98, 100 as shown in FIG. 16C or both of the exterior surfaces of the front and back covers 98, 100 as shown in FIG. 16A. However, both exterior surfaces of the front and back covers 98, 100 may be void of the object retention system 10 while one, neither, or both of the interior surfaces of the front and back covers 98, 100 are configured with ductile members.

Referring now to FIG. 17, a portable panel 68 is shown as implemented with an example object retention system 102. The various ductile members are configured in a skewed, non-normal, orientation with respect to the borders of the panel 68. However, it is the ductile members may be connected at the periphery and intermediate portions of an underlying support substrate 102, which can be sized and shaped in any configuration as shown by segmented tines. A frame may be disposed about the rigid support substrate and may have one or more tabs 104 that protrudes from the periphery and has a connection feature 70, such as an eye hole. The tab 104 may be formed at any one of the four corners or at any location along the four edges of the frame 102.

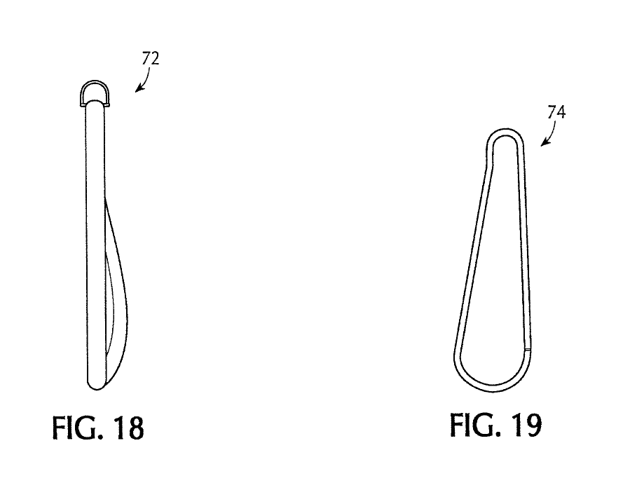

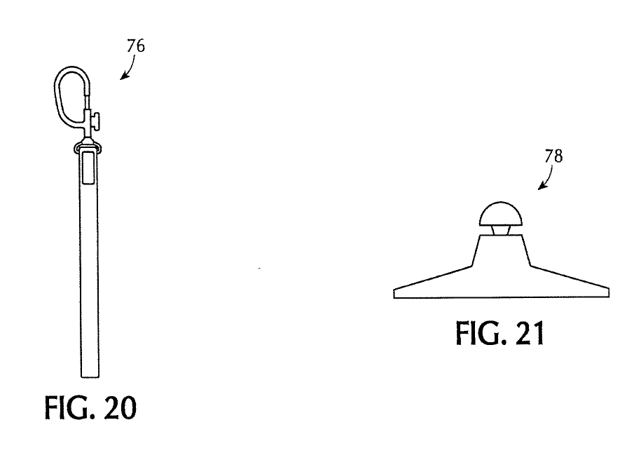

FIGS. 18-21 provide various connection members capable of engaging the connection feature displayed in FIG. 17. In FIG. 18, a loop of material 72 is fixed to a buckle, which allows for tied and handled engagement of the attached object retention system. FIG. 19 shows an example clip 74, such as a carabiner, that can selectively engage the connection feature 70 to secure an object retention system. FIG. 20 provides an example velcro leash 76 that may be attached to the tab 104 for convenient hand carry of the portable panel 78.

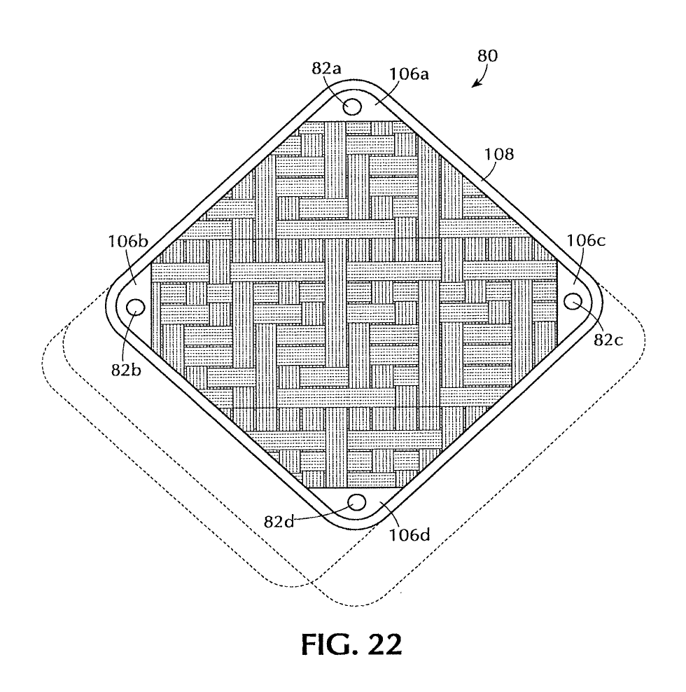

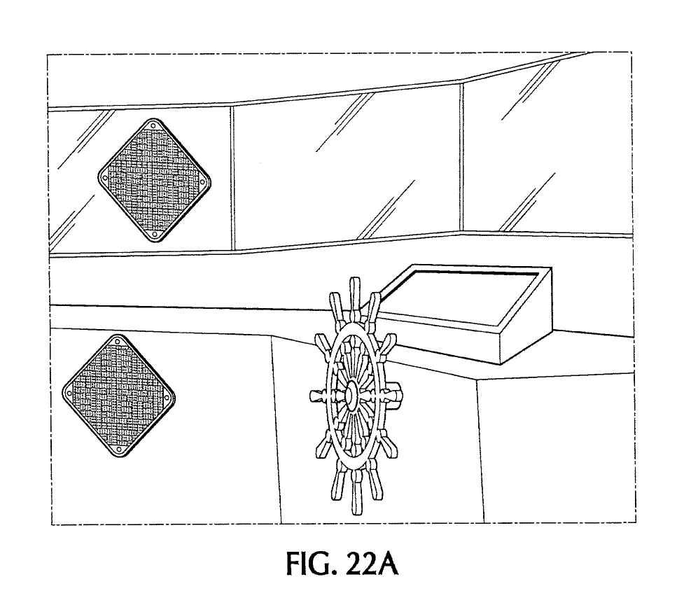

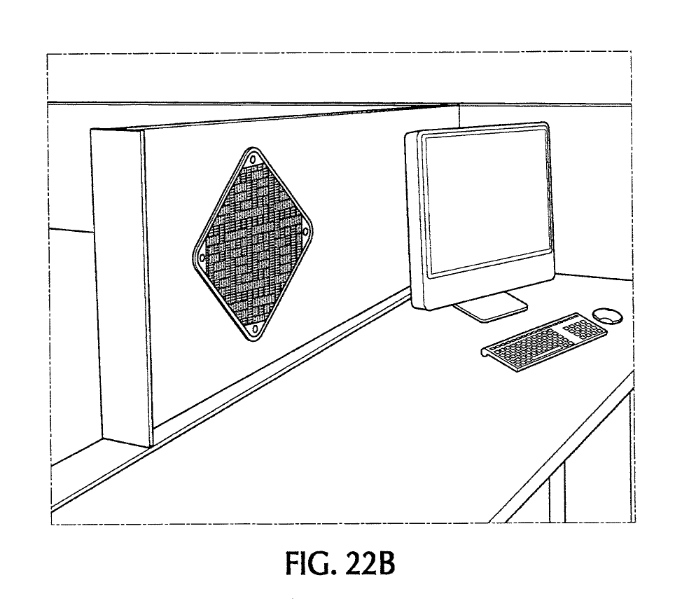

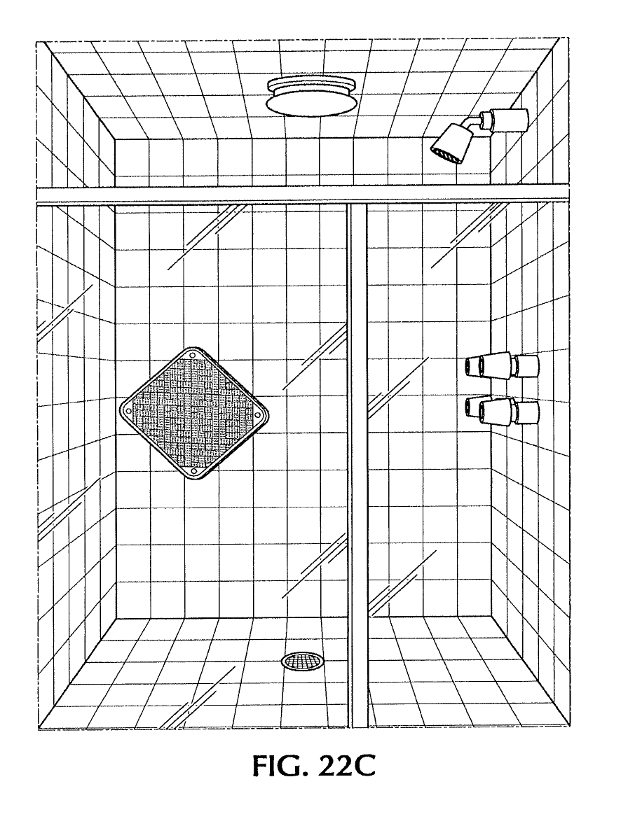

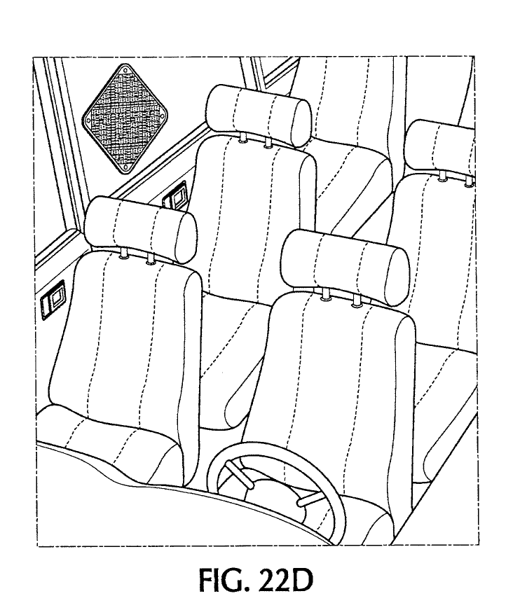

The connection feature 70 can also be engaged and secured with one or more suction cups 78 that allow for a portable panel 68 to be affixed to a window, glass surface, and window door. A support substrate can be configured, in various embodiments, to supply multiple connection features, as shown by the example object retention system 80 of FIG. 22. The portable object retention system 80 may be fabricated in a number of non-limiting different sizes as shown by the dash lines. Regardless of the size, the frame of the object retention system 80 may have multiple tabs 106 a-d that respectively provide connection features 82a-dd. With multiple connection features, the various connection features of FIGS. 18-21 can be utilized to provide customized handling of the object retention system 80.

In accordance with a non-limiting example, one or more suction cups 78 may provide connection between the tabs 106a, b, c, d and another smooth surface. FIGS. 22A-D generally illustrate a variety of non-limiting environments in which the object retention system 80 can be utilized. In FIG. 22A, multiple separate object retention systems 80 are mounted to various locations in a marine vehicle. Such engagement can employ several suction cups to securely affix to the various glass, chrome, and fiberglass surfaces present in a marine vessel. FIG. 22b shows how the object retention system 80 can be mounted to a smooth office divider, such as a dry erase board, with one or more suction cups.

In FIG. 22C, the object retention system 80 is mounted to a glass door of a shower. The different environments in which the object retention system 80 can be utilized, such as a kitchen, shower, and bathroom, the ductile members and support substrate can be tuned specifically to fit the tools, utensils, and objects commonly found in those environments to reduce clutter and improve visibility and organization.

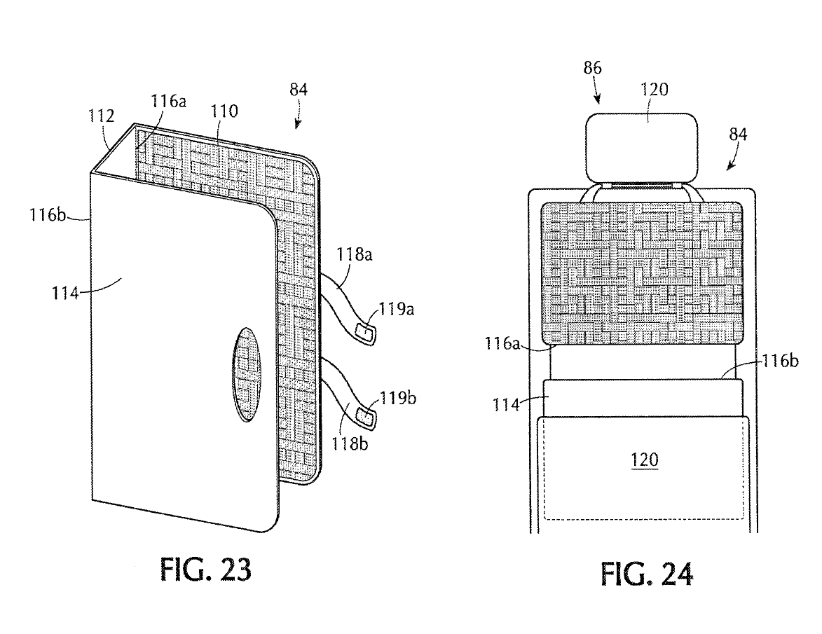

FIG. 22D displays the use of an example object retention system 80 as mounted to a window of an automobile, which can provide functionality of holding objects while shielding riders from sunlight. The proliferation of clutter and disorganization in automobiles can be mitigated with the integration of ductile members with tactile features in support substrates specifically designed to fit in predetermined portions of an automobile. FIGS. 23 and 24 illustrate an example object retention system configured as an automobile panel 84 that can be mounted to a rear of an automobile seat 86. The automobile panel 84 may have support substrate configured into first 110, second 112, and third 114 panels to provide rigid backing components sections that are interconnected by living hinges 116a and 116b. That is, the living hinges 116a and 116b allow the first 110, second 112, and third 114 panels to be connected and configurable to a wide range of positions in relation to one another, such as acute, oblique, and zero angular relationships.

The automobile panel 84 may have first and second attachment members 118a and 118b which are attached to the top edge of the panel 110. The attachment members 118a and 118b may be constructed of elastic or non-stretchable materials with one or both of the members 118a and 118b having first and second securing mechanisms 119a and 119b, which can be any type of fastener, such as hook and loop, snap, and button fasteners. To install the automobile panel 84 in accordance with some embodiments, the third panel 114 may be inserted into a storage pocket 120 on the back side of the seat 86, as shown in FIG. 24, which allows the first 110, second 112, and third 114 panels to lie substantially flat and present a plurality of ductile members for efficient use by one or more occupants of the automobile.

The size, operation, and construction of the living hinges 116a and) 6b is not limited to the configuration shown in FIGS. 23 and 24 and may be formed in an unlimited variety of configurations that can help to accommodate a variety of curvatures and discontinuities on the back side of the seat 86. The automobile panel 84 is shown in FIG. 24 with first and second ductile members 118a and 118b wrapped around the head rest and secured to each other through the securing mechanism 119a and 119b so that the automobile panel 84 hangs from the head rest without obscuring the head rest. The presentation of ductile members from some, but not all, of the automobile panel 84 can provide multi-functional applications of the various panels 110, 112, and 114 as different shapes are created by articulating the living hinges 116a and 116b.

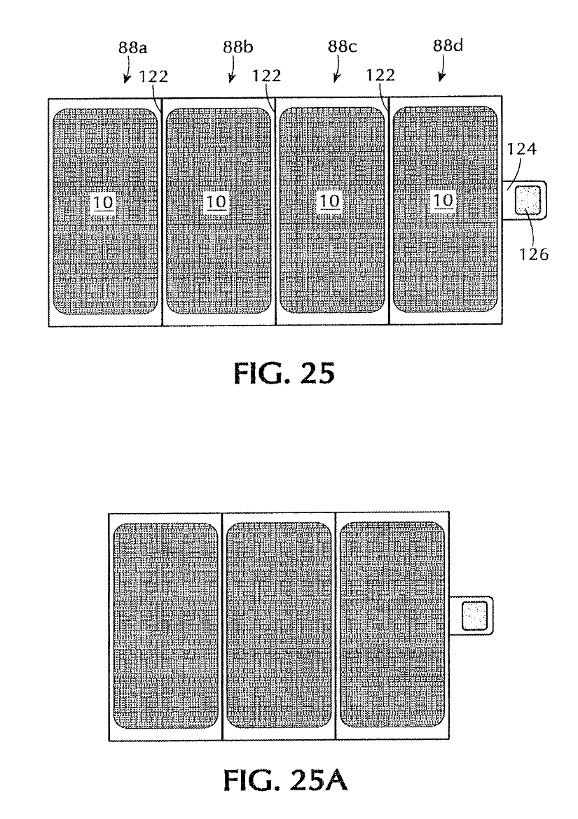

FIGS. 25 and 25A respectively display an example object retention system having a number of ductile member regions 10 on separate rigid panels 88a-88d connected by living hinges 122 in accordance with various embodiments. FIG. 25 illustrates a top view of the example object retention system having four panels 88a-88d each with ductile member regions 10 configured to operate independent of each other. Meanwhile, FIG. 25A shows a top view of the example object retention system with three such interconnected panels. The configurability if the independent panels can allow different presentations of the ductile member regions 10 as the living hinges 122 can allow one or more panels 88a-88d to be secured by tab 124 having at least one securing mechanism 126, such as hook and loop, button, and magnetic fastening means.

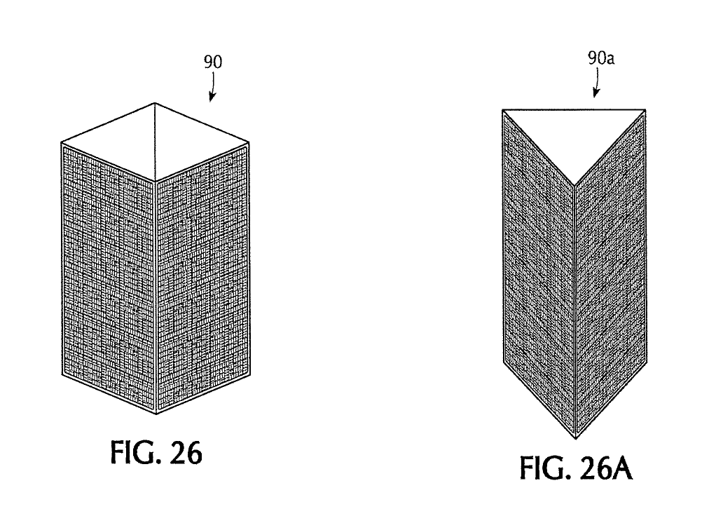

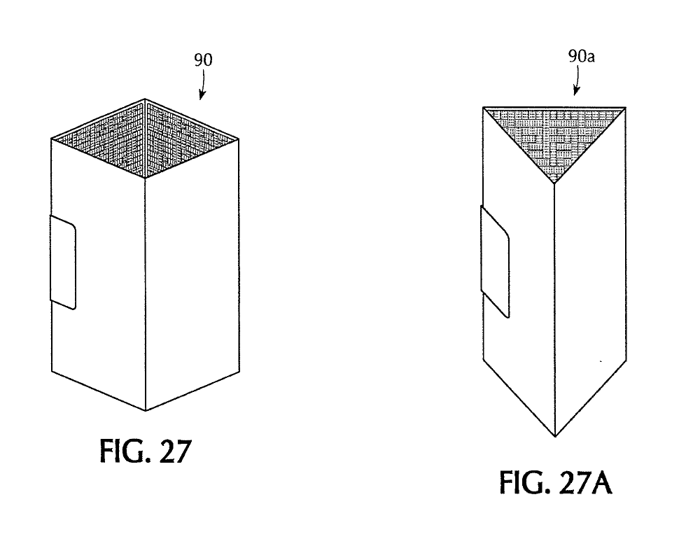

FIGS. 26, 26A, 27, and 27A respectively show how the example objet retention systems of FIGS. 25 and 25A can be shaped to provide free-standing structures 90 and 90a presenting multiple different ductile member regions in accordance with some embodiments. While not required or limiting, the free-standing structure 90 may be fabricated to allow a predetermined shape, such as the rectangular shape of FIG. 26 and triangular shape of FIG. 26A, to be efficiently constructed and held place. That is, the living hinges separating the various panels of the structures 90 and 90a can be formed with a length and orientation to correspond to a predetermined shape. As such, a sphere, pentagon, and tube can be possible free-standing structure configurations as the living hinges are oriented to provide the predetermined shapes and a plurality of ductile members to allow for the organization, presentation, and management of a number of differently sized and weighted objects.

FIGS. 27 and 27A show how the free-standing structures 90 and 90a can be secured with a tab and securing mechanism to present either side of the respective independent panels. As displayed, the plurality of ductile members can be configured to be enclosed within the structures 90 and 90a, which contrasts the outward presentation of the ductile members in FIGS. 26 and 26A. The ability to articulate the various panels to outwardly present either side of the panels can allow for the protection of objects secured by the ductile members. For example, a delicate object can be secured by one or more ductile members while the panels are outwardly facing and subsequently protected from inadvertent collisions by articulating the panels so that the ductile members face inward, or towards each other.

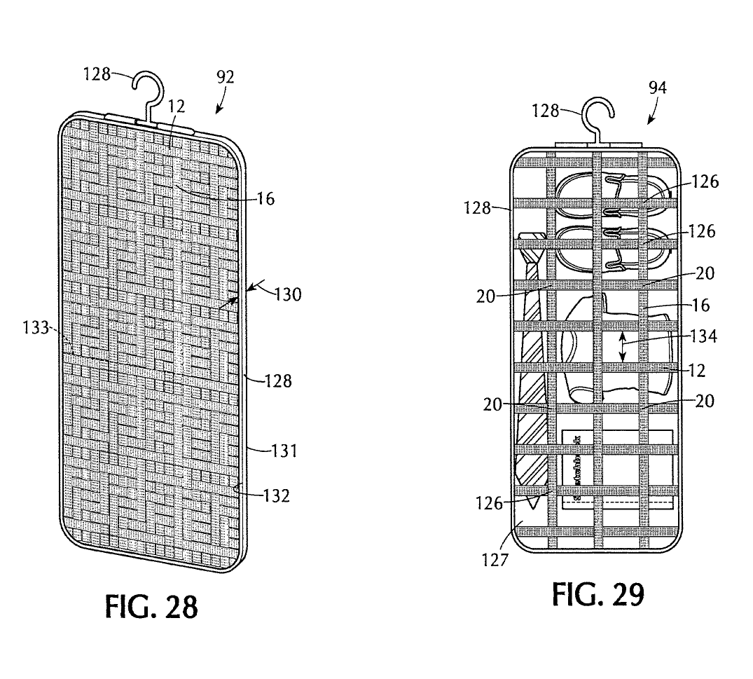

In FIGS. 28 and 29, opposite sides 92 and 94 of an example object retention panel are shown as constructed and operated in accordance with some embodiments. FIG. 28 displays a close knit weave of ductile members 12 and 16 oriented in orthogonal directions and attached to an underlying rigid substrate. The object retention panel is configured with a hook 128 that illustrates an example attachment means for securing the panel to a predetermined exterior object, such as a door, rod, handle, and knob. Various embodiments use multiple attachment means, like the hook 128 of FIGS. 28 and 29 along with a suction cup, to secure the panel to the chosen exterior object.

With the opposite sides of the object retention panel 92 and 94, different ductile member configurations can be provided. As shown, the first panel surface 92 has a continuous weave of interconnected ductile members 12 and 16 while the second panel surface 94 has a non-continuous weave that leaves gaps of predetermined sizes between the ductile members 12 and 16. The pattern, density, and orientation of weaving the ductile members 12 and 16 can differ from side to side; as illustrated to allow for the securement of objects with differing size, weight, and textures.

The example object retention panel may have a rigid or flexible support substrate 127 with or without a frame 128 having a thickness 130 defining opposed first and second sides 131, 132. The support substrate 127 may be attached closer to or at the first side 131 of the frame. The ductile members 12 and 16 may be attached closer to or at the second side 132 of the frame 128 so that the members 12 and 16 are gapped away from the rigid backing. The support substrate 127, in some embodiments, has one or more living hinges or pivoting mechanisms 133 which allows an upper portion 134 to translate onto lower portion 136. One or more of the ductile members 12 and 16 can operate to provide tension to the pivoting mechanism or living hinge 133 to allow for the engagement of an object from different directions due to the pivoted portions 134 and 136.

The various structural and operational configurations of an object retention system can provide the ability to efficiently secure and remove objects of varying size, weight and texture. Additionally, the use of one or more texture features can allow for increased friction to increase the ability to secure objects of greater weight and smoother texture. While the various embodiments discussed above have been directed to a variety of ductile member configurations, no single configuration is required or limited.

It is to be understood that even though numerous characteristics of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. For example, the particular elements may vary depending on the particular application without departing from the spirit and scope of the present technology.

What is claimed is:

1. An object retention system comprising:
a support substrate;
a plurality of ductile members extending across predetermined portions of the support substrate, at least one ductile member comprising a tactile feature increasing friction between the support substrate and the ductile feature; and
a non-slip member disposed between the support substrate and the plurality of ductile members.

2. The object retention system of claim 1, wherein at least one of the plurality of ductile members is oriented orthogonal to another one of the plurality of ductile members.

3. The object retention system of claim 1, wherein the support substrate has a curvilinear shape.

4. The object retention system of claim 1, wherein at least two of the plurality of ductile members have different widths.

5. The object retention system of claim 4, wherein the at least two of the plurality of ductile members are orthogonal to each other.

6. The object retention system of claim 4, wherein the at least two of the plurality of ductile members are parallel to each other.

7. The object retention system of claim 1, wherein adjacent ductile members of the plurality of ductile members contact each other.

8. The object retention system of claim 1, wherein adjacent ductile members of the plurality of ductile members are separated from each other by a predetermined gap distance.

9. The object retention system of claim 1, wherein at least one of the plurality of ductile members are anchored to the support substrate at least one location within a periphery of the support substrate.

10. The object retention system of claim 1, wherein at least one of the plurality of ductile members are anchored to the support substrate at multiple locations within a periphery of the support substrate.

11. The object retention system of claim 1, wherein at least two of the plurality of ductile members are anchored to the support substrate at least one location within a periphery of the support substrate.

12. The object retention system of claim 10, wherein the multiple locations form a predetermined pattern on the support substrate.

13. The object retention system of claim 12, wherein the predetermined pattern is a copyrightable design.

14. The object retention system of claim 12, wherein the at least one of the plurality of ductile members is anchored via a stitch concurrently engaging both the ductile member and the support substrate.

15. The object retention system of claim 12, wherein the at least one of the plurality of ductile members is anchored via a hook and loop fastener concurrently engaging both the ductile member and the support substrate.

16. An apparatus comprising:
a support substrate;
a plurality of ductile members extending across predetermined portions of the support substrate, each ductile member woven with a tactile feature increasing friction between the support substrate and the ductile feature; and
a slip resistant member disposed between the support substrate and the plurality of ductile members.

17. The apparatus of claim 16, wherein at least one of the plurality of ductile members comprises a continuous string of non-slip material.

18. The apparatus of claim 16, wherein at least one of the plurality of ductile members comprises parallel, separated rows of non-slip material.

19. An object retention structure comprising:
a support substrate providing a friction feature;
a plurality of ductile members extending across predetermined portions of the support substrate and friction feature, at least one ductile member comprising a tactile feature increasing friction between the friction feature and the ductile feature.

20. The object retention structure of claim 19, wherein the friction feature comprises a continuous sheet of non-slip material having varying thicknesses.
